(19) United States
(12) Patent Application Publication
(10) Pub. No.: US 2010/0124885 A1
(43) Pub. Date: May 20, 2010

(54) INTERFACE DEVICE

(76) Inventor: Ralph Sasse, Berlin (DE)

Correspondence Address: TEXAS INSTRUMENTS INCORPORATED, P O BOX 655474, M/S 3999, DALLAS, TX, 75265, US

(21) Appl. No.: 12/619,444

(22) Filed: Nov. 16, 2009

Related U.S. Application Data
(60) Provisional application No. 61/141,914, filed on Dec. 31, 2008.

(30) Foreign Application Priority Data
Nov. 19, 2008 (DE) 10 2008 057 969.6

(51) Int. Cl. H04B 7/005

(52) U.S. Cl. 455/41.3

(57) ABSTRACT

An interface device is provided for interfacing an independent navigation device with an RDS-capable radio receiver. The device includes an RDS-capable RF transmitter and a coupling means for coupling an audio output of the navigation device to the RF transmitter. Furthermore, the RF transmitter is adapted to detect an audio signal from the audio output of the navigation device and transmit the detected audio signal along with a TA/TP signal.

### CROSS-REFERENCE TO RELATED APPLICATIONS

This application claims priority to U.S. Application No. 61/141,914, filed Dec. 31, 2008, which claims priority to German Patent Application No. 10 2008 057 969.6, filed Nov. 19, 2008.

### TECHNICAL FIELD OF THE INVENTION

The invention generally relates to an interface device and, more particularly, to an interface device for interfacing an independent navigation device with a radio receiver.

### BACKGROUND OF THE INVENTION

Navigation devices are used widely in automobiles and other vehicles, which use GPS technology to obtain position data about the vehicle and issue directions or travel information accordingly. Navigation devices can be fixed in a vehicle as part of the vehicle's multimedia system, along with the stereo. The directions or travel information can be provided both on a display in the interior of the vehicle, for example as a road map, and through a loud speaker of the vehicle's multimedia system as spoken instructions. However, such fixed navigation devices are very expensive.

Independent or portable navigation devices (also called personal navigation devices or PNDs) are also available that are inexpensive and do not have to be fixed in a particular vehicle. When the PDA is issuing travel directions to the driver of the vehicle, these are played through the loudspeaker of the PDA. However, the sound quality of such loudspeakers can be quite poor and announcements from the loudspeaker of the PDA may be inaudible especially if, for example, a CD is playing on the stereo inside the vehicle. This means that the driver of the vehicle may instead have to look at the display of the navigation device, which can cause distraction and can be dangerous since he is required to divert his attention from the road ahead.

### BRIEF SUMMARY OF THE INVENTION

Embodiments of the invention provide an interface device for interfacing an independent navigation device with an RDS-capable radio receiver. The device includes an RDS-capable RF transmitter and a coupling means for coupling an audio output of the navigation device to the RF transmitter. Furthermore, the RF transmitter is adapted to detect an audio signal at the audio output of the navigation device and transmit the detected audio signal along with the RDS-TA/TP signals.

When the RF transmitter detects that an audio signal is being output from the navigation device, the RF transmitter transmits the audio signal from the navigation device along with a signal in the TA field of the RDS protocol. The RDS-capable radio receiver will be tuned to the frequency used by the RF transmitter in substantially the same way as if the RF transmitter were a conventional RDS radio station. Frequency negotiation in general will involve setting the RF transmitter to a well known (locally unused) frequency and tuning the radio receiver manually to that frequency. Tuning will be aided by virtue of the RDS TP search functionality, restricting the stations found by the radio receiver to those with RDS-TP flag set. Programme Service (PS)—an eight-character static display that represents the call letters or station identity name—can be used to visually confirm tuning to the RF transmitter. Advanced frequency negotiation may involve use of the Alternative Frequencies (AF) feature of RDS.

Once tuned successfully, the audio signal from the navigation device is played through the loudspeaker of the radio receiver. Since the radio receiver is RDS-capable, if, for example in a vehicle the CD player is playing when the audio signal from the navigation device is received, the CD can be paused using the RDS capabilities (the TA flag) of the radio receiver. In this way, the audio signal from the navigation device is always audible to the occupants of the vehicle. In addition most RDS-capable radio receivers will automatically raise the volume during the announcement. This means that the driver of the vehicle does not have to avert his gaze from the road to look at the display of the navigation device for travel information and thus safety is not compromised. A particular advantage of the device according to the invention is that it can be used in conjunction with an “off the shelf” portable navigation device and no modification is required to either the navigation device or to the vehicle's radio receiver.

The coupling means can be an audio cable. A standard audio cable can be used to connect the audio output of the navigation device that is normally fed to its loudspeaker to the RF transmitter. Alternatively the coupling means can be a network, in particular a wireless network, for example Bluetooth.

In a further embodiment, the RF transmitter can be further adapted to transmit a signal from the navigation device containing travel information for display on a digital display of the RIDS-capable radio receiver in text format. The instructions or travel information can then be displayed as text on a digital display of the radio receiver.

In an advantageous embodiment, the RF transmitter can be built into the navigation device. An RF transmitter can be provided that is adapted to fit inside a casing of the navigation device and that is coupled to the audio output of the device. This means that a separate transmitter set is not needed and therefore the number of components required is reduced.

The embodiments of the invention also provide a method of interfacing a navigation device with an RDS-capable radio receiver. The method includes coupling an audio output of the navigation device to an RDS-capable RF transmitter, detecting an audio signal output from the audio output of the navigation device, and using the RF transmitter to transmit the detected audio signal along with a TA/TP signal, receiving the audio signal at the radio receiver and playing the audio signal through a loudspeaker of the radio receiver.

### BRIEF DESCRIPTION OF THE DRAWINGS

For a more complete understanding of the invention, reference is now made to the following descriptions taken in conjunction with the accompanying drawings, I which:

FIG. 1 is a simplified schematic diagram of an interface device according to a first embodiment of the invention; and

FIG. 2 is a simplified schematic diagram of an implementation of an interface device according to a second embodiment of the invention.

### DETAILED DESCRIPTION OF THE INVENTION

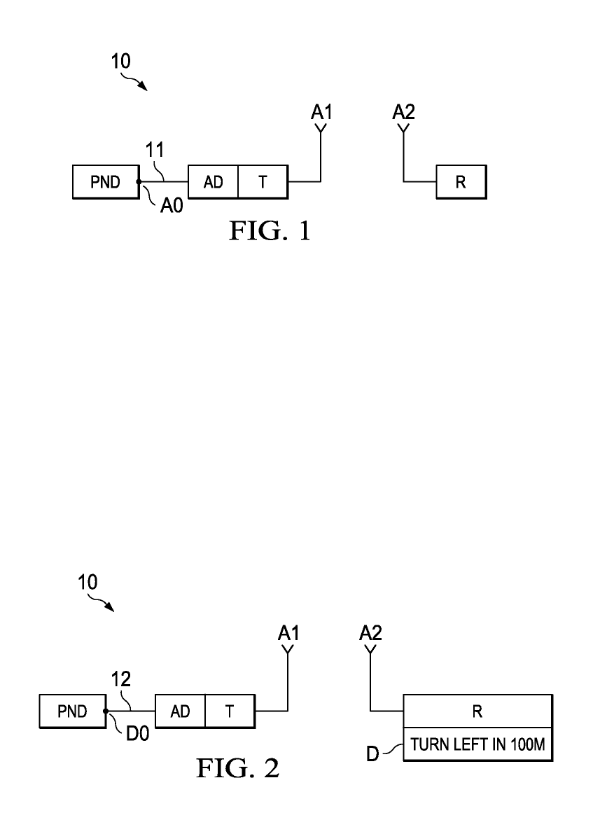

Referring to FIG. 1, an interface device 10 according to a first embodiment of the invention is shown. A navigation device PND, preferably a portable (personal) or independent navigation device, has an audio output AO that is coupled to an input of an RDS-capable RF transmitter T by means of an audio cable 11, for example. The audio output AO may also be connected to a loudspeaker (not shown) provided in the navigation device PND. The RF transmitter T is provided with an audio signal detector AD arranged so as to be coupled to the audio output AO via the cable 11 for detecting audio signals at the audio output AO of the navigation device PND.

An antenna A1 is coupled to the RF transmitter FM for transmission of signals from the RF transmitter. A Radio Data System (RDS) capable radio receiver R, for example a car radio, is situated within range of the RF transmitter T so that it can receive RF signals transmitted from the transmitter T. The RDS-capable radio receiver R is provided with an antenna A2 for receiving RF signals and would typically, for example, be connected or be part of a stereo fitted in a vehicle, in particular a car.

By RDS-capable, it is meant that the transmitter T and the receiver R are compatible with the European “Radio Data System” protocol (RDS) and/or the corresponding US “Radio Broadcast Data System” protocol (RBDS). These are protocols for sending small amounts of digital information using conventional FM radio broadcasts. The RDS system standardizes several types of transmitted information, including time, track/artist information and station identification. One important and useful feature of the RDS protocol is that it contains Traffic Announcement and Traffic Programme (TA and TP, respectively) information fields. This means that an RDS-capable radio receiver (especially when fitted into a motor vehicle) can be set to pay special attention to the TA/TP flags. The TP flag is used to find only those radio stations in the vicinity of the vehicle that regularly broadcast traffic bulletins. The TA field is used to temporarily suspend the currently selected audio source and play the traffic announcement instead. The TA field usually also raises the volume of the vehicle's stereo so that the traffic announcement is clearly audible to the driver through the loudspeaker of the RDS-capable radio receiver.

In operation, when the navigation device PND issues travel instructions as an audio signal, the audio signal is output at the audio output AO of the navigation device PND. The audio signal is then transmitted to the audio detector AD provided in the transmitter T via the audio cable 11, where it is detected by the audio detector AD. The transmitter T therefore detects the audio signals output from the navigation device PND at its audio output AO. The detected audio signal is then transmitted by the transmitter T via its antenna A1 along with the TA/TP fields of the RDS protocol. Furthermore, the RF transmitter T is adapted to permanently broadcast the TP signal so that the receiver R always tunes to the frequency of the transmitter T, equivalent to the frequency of a radio station broadcasting a traffic bulletin. In this way, the audio signals output from the navigation device PND and detected by the audio detector AD are received at the RDS-capable receiver R via its antenna A2.

When an audio signal broadcast by the transmitter T is received at the receiver R, a tape or CD playing on the associated stereo is paused and the receiver R switches to the output of the RDS tuner. The audio signal is then played from the output of the RDS tuner through the loudspeaker (not shown) of the receiver R. The TA flag may also raise the volume of the loudspeaker of the receiver R while the audio signal received from the transmitter T is output via the loudspeaker of the receiver R. Therefore the travel instructions issued from the navigation device PDA are played through the loudspeaker of the receiver R in an audible manner, without the need for any modification to either the receiver R or the navigation device PDA.

FIG. 2 shows an alternative embodiment of the invention in which, as well as or instead of transmitting audio signals from the navigation device, the transmitter T transmits signals from the navigation device containing travel information for display on a digital display D of the RDS-capable radio receiver R in text format.

The structure and operation of the embodiment shown in FIG. 2 is the same as that shown in FIG. 1 and described above, except that the transmitter T is connected to a digital output DO of the navigation device PND via a cable 12 and is adapted to detect digital signals from the navigation device PND containing travel information in text format. The transmitter T then transmits the detected signals in RDS Radio Text format (RT) along with the permanently broadcasted TP signal via the antenna A1. The signals are then received at the receiver R via the antenna A2 and the text signals are displayed on the digital display D so that the travel instructions, for example “TURN LEFT IN 100 M” can be read from the display D.

Although the invention has been described hereinabove with reference to specific embodiments, it is not limited to these embodiments and no doubt further alternatives will occur to the skilled person that lie within the scope of the invention as claimed.

For example, instead of being separate from the navigation device PND and coupled to it via the audio cable 11 or the cable 12, the RF transmitter T could also be part of the navigation device PND and/or be provided inside the navigation device PND. Furthermore, a transceiver, preferably an FM transceiver, could be used instead of the RF transmitter T. Instead of an audio cable 11, the transmitter T could be coupled to the navigation device PND over a network (fixed or wireless, for example Bluetooth).

What is claimed is:

1. An interface device for interfacing an independent navigation device with an RDS-capable radio receiver, the device comprising:
an RDS-capable RF transmitter; and
a coupling means for coupling an audio output of the navigation, device to the RF transmitter, wherein the RF transmitter is adapted to detect an audio signal at the audio output of the navigation device and transmit the detected audio signal along with a TA/TP signal.

2. The interface device according to claim 1, wherein the coupling means is an audio cable.

3. The interface device according to claim 1, wherein the coupling means is a network.

4. The interface device according to claim 3, wherein the network is a wireless network.

5. The interface device according to claim 1, wherein the RDS-capable RF transmitter is further adapted to transmit a signal from the navigation device containing travel information for display on a digital display of the RDS-radio receiver in text format.

6. The interface device according to claim 2, wherein the RDS-capable RF transmitter is further adapted to transmit a signal from the navigation device containing travel information for display on a digital display of the RDS-radio receiver in text format.

7. The interface device according to claim 3, wherein the RDS-capable RF transmitter is further adapted to transmit a signal from the navigation device containing travel information for display on a digital display of the RDS-radio receiver in text format.

8. The interface device according to claim 4, wherein the RDS-capable RF transmitter is further adapted to transmit a signal from the navigation device containing travel information for display on a digital display of the RDS-radio receiver in text format.

9. The interface device according to claim 5, wherein the RDS-capable RF transmitter is adapted to permanently broadcast the TP signal and eventually the TA signal if an audio signal is detected at the audio output of the navigation device.

10. The interface device according to claim 6, wherein the RDS-capable RF transmitter is adapted to permanently broadcast the TP signal and eventually the TA signal if an audio signal is detected at the audio output of the navigation device.

11. The interface device according to claim 7, wherein the RDS-capable RF transmitter is adapted to permanently broadcast the TP signal and eventually the TA signal if an audio signal is detected at the audio output of the navigation device.

12. The interface device according to claim 8, wherein the RDS-capable RF transmitter is adapted to permanently broadcast the TP signal and eventually the TA signal if an audio signal is detected at the audio output of the navigation device.

13. The interface device according to claim 1, wherein the RF transmitter is built into the navigation device.

14. The interface device according to claim 2, wherein the RF transmitter is built into the navigation device.

15. An interface device for interfacing an independent navigation device with an RDS-capable radio receiver, the device comprising:
an RDS-capable RF transmitter; and
a coupler coupling an audio output of the navigation device to the RF transmitter, wherein the RF transmitter is adapted to detect an audio signal at the audio output of the navigation device and transmit the detected audio signal along with a TA/TP signal.

16. A method of interfacing an independent navigation device with an RDS-capable radio receiver, the method comprising:
coupling an audio output of the navigation device to an RDS-capable RF transmitter;
detecting an audio signal output from the audio output of the navigation device at the RF transmitter;
using the RF transmitter to transmit the detected audio signal along with a TA/TP signal;
receiving the audio signal at the radio receiver; and
playing the audio signal through a loudspeaker of the radio receiver.
